(19) United States
(12) Patent Application Publication
(10) Pub. No.: US 2014/0295021 A1
(43) Pub. Date: Oct. 2, 2014

(54) Scented feeder block

(71) Applicant: Mark Bowles, Waco, TX (US)

(72) Inventor: Mark Bowles, Waco, TX (US)

(21) Appl. No.: 13/986,046

(22) Filed: Mar. 27, 2013

(51) Int. Cl. A23K 1/18; A23K 1/00

(52) U.S. Cl. CPC A23K 1/1813; A23K 1/002
USPC 426/1

(57) ABSTRACT

Scented feeder blocks for attracting game include a body at least partially formed from an edible material having a depression formed in an exterior surface, and a scent cell in the depression. The scent cell can include a stabilizer, an edible component, and a scented component. The stabilizer, the depression, or combinations thereof resist degradation of the scent cell, and the stabilizer slows dispersion of the scented component from the scent cell. Methods for forming scented feeder blocks include forming a depression in an exterior surface of a body at least partially formed from an edible material, heating a stabilizer to a first temperature such that the stabilizer melts, adding an edible component to the stabilizer, cooling the stabilizer to a second temperature less than the first and adding a scented component, and cooling the stabilizer to a third temperature less than the second such that the stabilizer solidifies.

### FIELD

Embodiments of the present disclosure relate, generally, to lures and/or similar animal attractants used to attract animals to a location, and more specifically, to a scented mineral and/or nutrient body usable to attract deer or other game to facilitate hunting and other activities.

### BACKGROUND

When maintaining a hunting lease or a similar site where deer or other types of game are hunted, or other areas where it is desirable to attract and/or control the location of animals, it is common to place a scented and/or nutritious substance at a desired location to lure the animals thereto. “Deer feeder blocks” are commercially available, these blocks including grain, feed, salt, and/or other substances desirable to deer, formed into a block and/or brick-like shape. These blocks can be provided with grooves and/or holes to enable the blocks to be readily mounted and/or hung from desired locations, such as trees or fence posts, where they can be readily accessed by deer.

While salt, grain, and/or feed can be attractive to deer independent of any additives, a deer feeder block is often dipped in a scented substance to enable deer to detect the block from a greater distance. Absent such a process, the effectiveness of a feeder block is fairly limited due to the fact that a deer would only be attracted to an unscented feeder block when immediately adjacent thereto. However, the application of a scented coating to a feeder block generally only affects the surface of the block, or possibly a limited depth thereof as the coating permeates into interstices in the material. As such, as the outer portion of the block is consumed by deer, the coating is also consumed, leaving behind a body of material lacking this scented additive. Additionally, precipitation, or simply exposure to humidity, can wash the coating away, significantly reducing the effectiveness of the coated block. Even absent external environmental factors, it is common for a feeder block to outlast the effectiveness of a scented coating as the scent dissipates during the life of the block. Further, conventional scented coatings are generally only able to be detected by deer from a short distance away, such as 100-200 yards, limiting the effectiveness thereof.

A need exists for bodies of edible material able to attract deer or other game from a significant distance (e.g., up to 500 yards, or more), for an extended period of time, throughout the life of the object.

A need also exists for bodies of edible material having built-in features to protect scented and/or attractive components from consumption and/or environmental exposure to prolong the useful life thereof.

A further need exists for bodies of edible material having an integral scent cell with components and features that resist degradation and both prolong the effectiveness and increase the usable life thereof.

Embodiments usable within the scope of the present disclosure meet these needs.

### SUMMARY

Embodiments usable within the scope of the present disclosure include scented feeder blocks and/or similar objects that include a body at least partially formed from an edible material (e.g., sodium chloride, other salts, grains, feeds, etc.) having a depression formed in an exterior surface thereof, and a scent cell disposed in the depression. The scent cell can include one or more stabilizers, edible components, and/or scented components, such that the stabilizer(s), the depression, or combinations thereof resist degradation of the scent cell (e.g., due to precipitation and/or other environmental factors), while the stabilizer slows dispersion of the scented component from the scent cell (e.g., to prolong the usable life thereof).

While embodiments described herein may reference a “block,” it should be understood that embodiments usable within the scope of the present disclosure can include any shape and/or dimensions, as desired, and use of the term block is not intended to limit the possible shapes and/or dimensions thereof. Further, while specific embodiments described herein may include a single depression having a single scent cell therein, it should be understood that any number of depressions and/or scent cells can be used without departing from the scope of the present disclosure, and that depressions can include any shape and/or dimensions. For example, a usable depression could include a generally cylindrical bore having a diameter ranging from 0.25 inches to 3.5 inches and/or a depth ranging from 0.25 inches to 3.0 inches, such that the depression extends only partially through the thickness of the body of edible material, while one or more sidewalls thereof serve to protect the scent cell therein from exposure to environmental factors.

Usable scent cells can include stabilizers, such as paraffin wax and/or bees wax, or other similar compounds, edible components, such as sugar, corn syrup, and/or other similar substances, and one or more scented components—preferably concentrated scented components detectable by deer up to 500 yards therefrom. Exemplary scents include odors simulating apple, acorn, peanut butter, and wild berry. In an embodiment, the scent cell can include from 10 to 20 percent of the edible component(s) by volume (e.g., 3 ounces of edible component per pound of stabilizer).

For example, in an embodiment, a scent cell can be manufactured by heating a stabilizer until the stabilizer melts, adding one or more edible components to the stabilizer, cooling the stabilizer to a lower temperature where the stabilizer remains molten, but the scented component(s) will not boil, adding the scented component(s) to the stabilizer, then cooling the mixture until the scent cell solidifies. When placed in a depression formed in the exterior surface of a body of edible material, the depression can provide physical protection to the scent cell, while the stabilizer can slow dispersion of the scented component while also providing additional physical protection.

### BRIEF DESCRIPTION OF THE DRAWINGS

In the detailed description of various embodiments usable within the scope of the present disclosure, presented below, reference is made to the accompanying drawings, in which:

FIG. 1 depicts an isometric view of an embodiment of a scented feeder block usable within the scope of the present disclosure.

FIG. 2 depicts a front view of the block of FIG. 1.

FIG. 3 depicts a top view of the block of FIG. 1.

FIG. 4 depicts a bottom view of the block of FIG. 1.

FIG. 5 depicts a left side view of the block of FIG. 1.

FIG. 6 depicts a right side view of the block of FIG. 1.

FIG. 7 depicts a back view of the block of FIG. 1.

FIG. 8 depicts a side, cross-sectional view of the block of FIG. 1, taken along line 8-8 of FIG. 2.

FIG. 9 depicts an embodiment of a method usable to make scented feeder blocks usable within the scope of the present disclosure.

One or more embodiments are described below with reference to the listed Figures.

### DETAILED DESCRIPTION OF THE EMBODIMENTS

Before describing selected embodiments of the present invention in detail, it is to be understood that the present invention is not limited to the particular embodiments described herein. The disclosure and description herein is illustrative and explanatory of one or more presently preferred embodiments of the invention and variations thereof, and it will be appreciated by those skilled in the art that various changes in the design, organization, order of operation, means of operation, equipment structures and location, methodology, and use of mechanical equivalents may be made without departing from the spirit of the invention.

As well, it should be understood the drawings are intended illustrate and plainly disclose presently preferred embodiments of the invention to one of skill in the art, but are not intended to be manufacturing level drawings or renditions of final products and may include simplified conceptual views as desired for easier and quicker understanding or explanation of the invention. As well, the relative size and arrangement of the components may differ from that shown and still operate within the spirit of the invention as described throughout the present application.

Moreover, it will be understood that various directions such as “upper”, “lower”, “bottom”, “top”, “left”, “right”, and so forth are made only with respect to explanation in conjunction with the drawings, and that the components may be oriented differently, for instance, during transportation and manufacturing as well as operation. Because many varying and different embodiments may be made within the scope of the inventive concept(s) herein taught, and because many modifications may be made in the embodiments described herein, it is to be understood that the details herein are to be interpreted as illustrative and non-limiting.

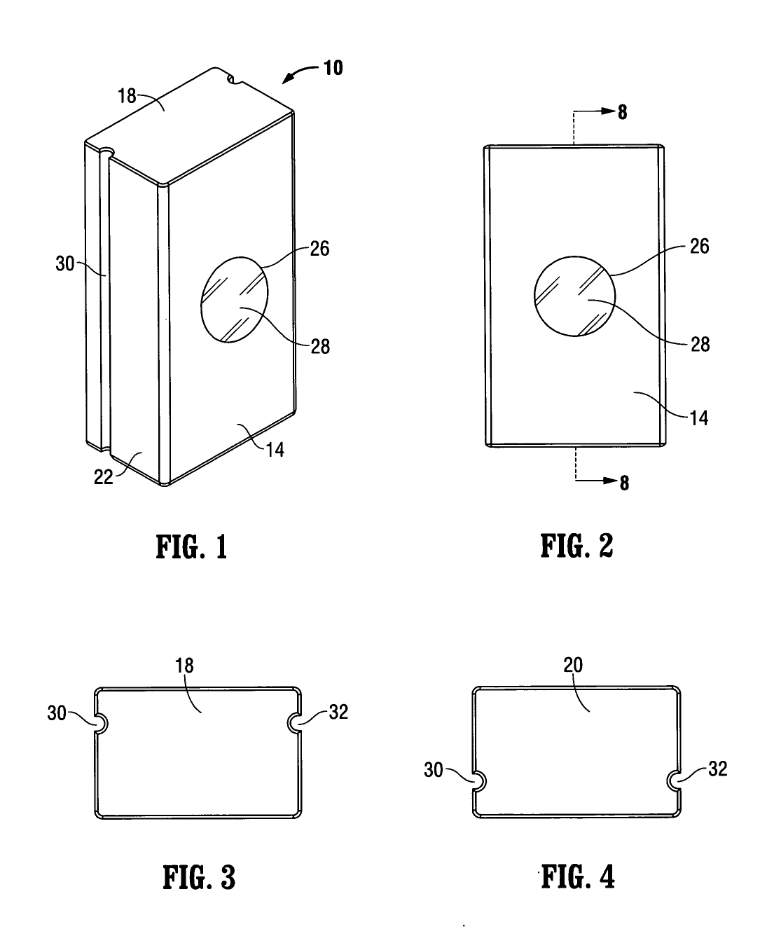

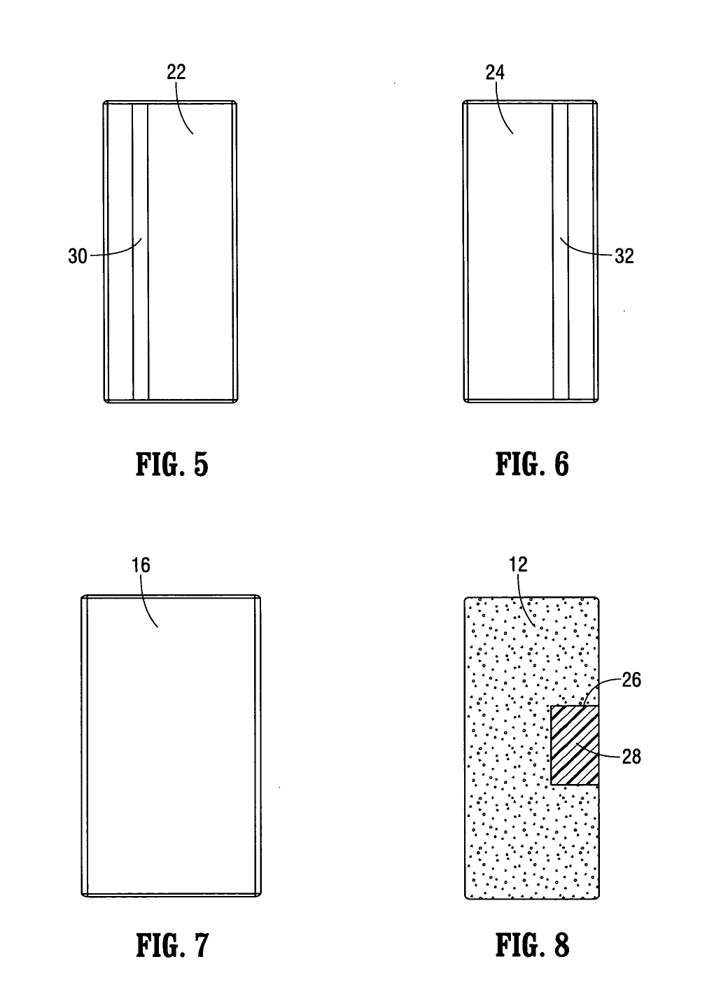

FIG. 1 depicts an isometric view of an embodiment of a feeder block (10), usable within the scope of the present disclosure, is shown. The depicted block (10) is illustrated having a generally rectangular, brick-like shape (e.g., 7.0 inches in length, 4.25 inches in width, and 2.5 inches in depth); however, as described above, it should be understood that use of a “block” shape is representative of a single embodiment, and embodiments usable within the scope of the present disclosure could include any shape and/or dimensions. FIGS. 2 through 7 depicts various views of the exterior of the block (10). Specifically, FIG. 2 depicts a front view, FIG. 3 depicts a top view, FIG. 4 depicts a bottom view, FIG. 5 depicts a left side view, FIG. 6 depicts a right side view, and FIG. 7 depicts a back view thereof. FIG. 8 depicts a side, cross-sectional view of the block (10), taken along line 8-8 of FIG. 2.

The depicted embodiment of the block (10) is shown having a front surface (14) opposite a back surface (16), a top surface (18) opposite a bottom surface (20), and a left side surface (22) opposite a right side surface (24). Each of the surfaces (14, 16, 18, 20, 22, 24) is shown as a generally flat, contiguous surface; however, in various embodiments, one or more surfaces could be curved, irregular, and/or have one or more protrusions, grooves, depressions, or the like formed therein. The block (10) is shown as a generally solid body (12), formed form a packed and/or bonded edible material, such as sodium chloride and/or other salts or minerals attractive and/or nutritious to deer or other animals, grain, feed, corn syrup or similar sweetening, binding, and/or stabilizing additives, or other suitable edible materials. To enhance the attractive and/or nutritious features of the body (12), the block (10) can be dipped, sprayed, painted, and/or otherwise provided with a scented and/or edible coating, as described above, though it should be noted that embodiments usable within the scope of the present disclosures do not require use of such a coating or similar additives due to the effectiveness of the scent cell, and the limitations of such coatings, as described above.

The front surface (14) of the block (10) is shown having a depression (26) formed therein. While embodiments usable within the scope of the present disclosure can include any number of depressions, having any shape or dimensions, the depicted depression (26) is shown having a generally cylindrical shape (e.g., a round hole having a circular base and a curved sidewall extending upward from the perimeter of the base), which in an embodiment, can have a diameter ranging from 0.25 inches to 3.5 inches, and a depth less than the depth of the block (10) (e.g., ranging from 0.25 inches to 3.0 inches). A scent cell (28), the composition and characteristics thereof being described above and below, can be positioned within the depression (26), such that the scent cell (28) partially or wholly occupies the depression (26).

The left side surface (22) and right side surface (24) are shown having a first groove (30) and a second groove (32), respectively, formed therein. The grooves (30, 32) are usable to facilitate handling of the block (10) (e.g., manual or tool-assisted carrying thereof), as well as provide a feature usable for mounting the block, such as by engaging a rope, cable, or similar elongate member, and/or by engaging protruding panels and/or flanges of a holder, wall, fence, or similar surface. It should be understood that the depicted grooves (30, 32) are a single embodiment of one usable mounting feature, and that embodiments usable within the scope of the present disclosure can include any number and/or type of mounting features, or wholly lack specific mounting features. For example, published United States patent application 2012/0227669, the entirety of which is incorporated herein by reference, describes a feed block having holes usable to retain a bolt, spike, or screw for fastening the feed block to a stationary object, such as a tree. Additionally, a generally solid block lacking orifices and/or grooves for facilitating mounting (e.g., having continuous, featureless surfaces) could be fastened to a desired surface or object (e.g., a tree, fence, wall, post, etc.) using adhesives, by attaching fasteners to and/or through the body of the block, by securing a cable, cord, rope, or similar elongate member about the body of the block, or other similar means.

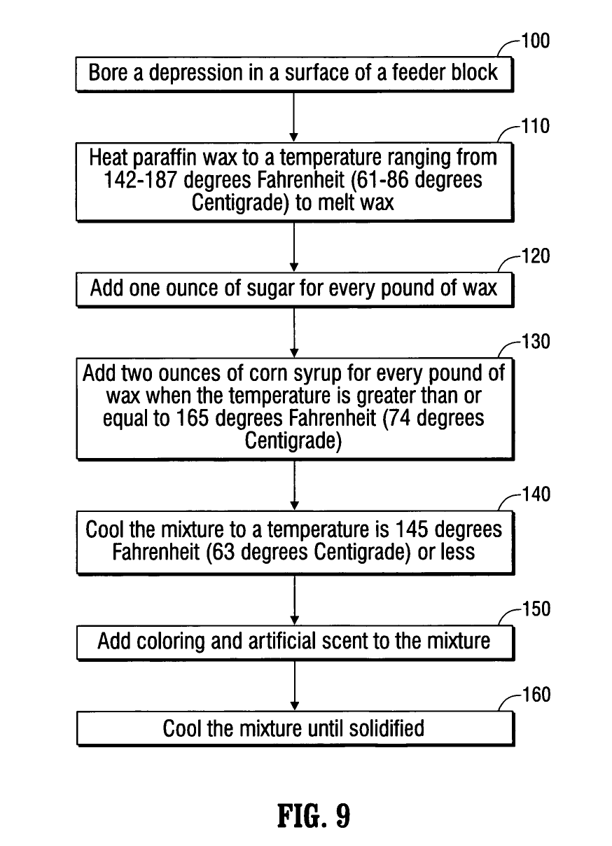

FIG. 9 depicts an embodiment usable to make scent cells usable with embodiments of the depicted and described feeder blocks; however, it should be understood that the depicted method is an exemplary embodiment and that substitutions of components, variations in the order of steps undertaken, modifications in temperature, and other deviations from the exemplary embodiment can be made without departing from the scope of the present disclosure. It should also be noted that while a single scent cell could be manufactured using the described method, multiple scent cells could be manufactured at one time, e.g., through a batch process. For example, quantities of materials sufficient to produce multiple scent cells could be liquefied, mixed, etc., then provided into depressions or other suitable regions of feeder blocks before cooling, or alternatively, allowed to solidify, shaped, and placed in depressions of feeder blocks.

Specifically FIG. 9 describes that after obtaining a feeder block (e.g., a rectangular block 7.0 inches in length, 4.25 inches in width, and 2.5 inches in thickness, similar to the block (10) shown in FIGS. 1 through 8, or any other similar body of edible material having any desired shape and/or dimensions, as described above), a depression can be bored in the surface of the feeder block (100). In an embodiment, a high speed boring bit capable of boring through high density salts and/or other minerals can be used, though a depression could be formed through any other method, using any type of electrical, fluid-driven, or manual tool, by hand, through dissolution of a portion of the block, or any other means. In other embodiments, a block can be formed having a suitable depression without requiring boring and/or modification thereof.

Paraffin wax can then be heated to a temperature suitable to melt and/or liquefy the wax (110). Exemplary temperatures usable to melt the wax can range from 142 to 187 degrees Fahrenheit, depending on the quality of the wax. It should be understood that while FIG. 9 describes use of paraffin wax, bees wax could be used as an organic alternative, or other waxes and/or stabilizers or combinations of stabilizers can be used without departing from the scope of the present disclosure, so long as the stabilizer used does not repel deer or other game or inhibit the effectiveness of the scented components. Suitable temperatures usable to liquefy the one or more stabilizers can be selected depending on the characteristics thereof. Depending on the number of scent cells that are manufactured at one time, the liquefied wax could then be provided into the depression formed in a feeder block, or retained in a separate vessel for the subsequent addition of components, mixing, heating, cooling, etc.

To the melted wax, one or more edible components and/or sweeteners can be added. For example, FIG. 9 describes adding one ounce of sugar for every pound of wax (120). Sugar or a similar substance (e.g., fructose, fruit extracts, corn and/or grain extracts, or other artificial and/or natural sweeteners) can be used to provide the scent cell with a “sweet” taste and/or odor. FIG. 9 further describes adding two ounces of corn syrup for every pound of wax (130). Due to the properties of corn syrup (e.g., viscosity, melting point, etc.), in an embodiment, the mixture can be retained at a temperature sufficiently warm to promote flow and miscibility of the corn syrup, such as 165 degrees Fahrenheit. Corn syrup and/or similar additives can facilitate both the taste and/or odor of the resulting scent cell, as well as the consistency and stability thereof. In other embodiments, molasses, honey, or other types of sweeteners could be added without departing from the scope of the present disclosure. The quantity of sweetener(s) added can be varied depending on the properties thereof and the desired consistency and sweetness of the resulting scent cell. For example, when producing the embodiment described in FIG. 9, including one ounce of sugar and two ounces of corn syrup per pound of wax, the sugar and corn syrup can be heated to a “hard rock” stage, then allowed to cool, resulting in a finished scent cell having a significant hardness/durability without preventing the dispersion of scented components therefrom. Additionally, the quantities of sweeteners described in FIG. 9 avoid producing an overly-sweet scent cell, which may be consumed prematurely by deer or other animals, reducing the useful life of the feeder block.

The mixture can then be cooled, generally to a temperature of 145 degrees Fahrenheit or less (140). The temperature to which the mixture is cooled can be selected such that the wax and/or other stabilizers, and/or other components of the mixture remain in a liquid state, but scented and/or colored components selected for addition to the scent cell will not boil and/or otherwise become denatured, modified, or undesirably affected. Once cooled, one or more scented components, and in an embodiment, artificial coloring, can be added to the mixture (150). While any scent-producing component can be used without departing from the scope of the present disclosure, exemplary scented components are available from Agri-Flavors, Inc., of Guntersville, Ala., and can include, by way of example, sodium bicarbonate, citric acid, natural and artificial sweeteners, and natural and artificial concentrated flavors. While any type of coloring that would not impede the effectiveness of the feeder block can be used, exemplary artificial colors are available from Candlechem Company, Inc. of Brockton, Mass.

Exemplary embodiments that include scents available from Agri-Flavors, Inc. and colorings available from Candlechem Company, Inc can include Apple Scent and Spice Apple Coloring, Peanut Butter Scent and French Vanilla Coloring, Acorn Scent and Spiced Pumpkin Coloring, and Berry Scent and Blueberry Coloring. In an embodiment, four ounces of scent concentrate can be used for every twenty-five pounds of wax.

After the addition of scented and/or colored components, the components can be mixed, e.g., to ensure even dispersion throughout; additionally and/or alternatively, the components can be mixed continuously and/or periodically throughout the process described above (e.g., after the addition of each component). The mixture can then be cooled such that the wax and/or other components solidify (160). Prior to cooling the mixture, it can be poured and/or transferred into a depression in a feeder block, such that as the mixture cools and solidifies, a scent cell is formed therein. Alternatively, the mixture can be cooled in a separate vessel, then shaped and/or cut into shapes that can be provided into feeder blocks. After the scent cell has sufficiently cooled, the scent cell and/or the feeder block can be wholly or partially covered, e.g., for transport, sale, and/or to protect the scent cell from environmental exposure until the feeder block is deployed for use.

Embodiments described herein thereby provide feeder blocks and methods that enable odors to be detected by deer or similar animals from a significant distance away (e.g., up to 500 yards), through use of scent cells designed to last throughout the life of the feeder block. For example, placement in a protected depression within a body of edible material can protect a scent cell from degradation caused by environmental factors and consumption by animals, while use of stabilizers that slow the dispersion of components therefrom enables the scent cell to last throughout the life of the feeder block.

While various embodiments usable within the scope of the present disclosure have been described with emphasis, it should be understood that within the scope of the appended claims, the present invention can be practiced other than as specifically described herein.

What is claimed is:

1. A scented feeder block for attracting game, the block comprising:
a body at least partially formed from an edible material and comprising an exterior surface having a depression formed therein; and
a scent cell disposed in the depression, wherein the scent cell comprises a stabilizer, an edible component, and a scented component, wherein the stabilizer, the depression, or combinations thereof resist degradation of the scent cell, and wherein the stabilizer slows dispersion of the scented component from the scent cell.

2. The block of claim 1, wherein the edible material comprises sodium chloride, another edible salt, or combinations thereof.

3. The block of claim 1, wherein the edible material is adapted to attract deer, nourish deer, or combinations thereof.

4. The block of claim 1, wherein the depression comprises a diameter ranging from 0.25 inches to 3.5 inches.

5. The block of claim 1, wherein the depression comprises a depth less than a width of the body.

6. The block of claim 5, wherein the depression comprises at least one sidewall.

7. The block of claim 5, wherein the depth of the depression ranges from 0.25 inches to 3.0 inches.

8. The block of claim 1, wherein the depression comprises a generally cylindrical shape.

9. The block of claim 1, wherein the stabilizer comprises paraffin wax, bees wax, or combinations thereof.

10. The block of claim 1, wherein the edible component comprises sugar, corn syrup, or combinations thereof.

11. The block of claim 1, wherein the scented component comprises a concentrated component adapted to provide an odor simulating apple, acorn, peanut butter, or wildberry.

12. The block of claim 1, wherein the scent cell comprises from 10 to 20 percent of the edible component by volume.

13. The block of claim 12, wherein the scent cell comprises three ounces of the edible component per pound of stabilizer.

14. A method for forming a scented feeder block, the method comprising the steps of:
providing a body at least partially formed from an edible material and comprising an exterior surface;
forming a depression in the exterior surface;
heating a stabilizer to a first temperature thereby melting the stabilizer and providing the stabilizer into the depression;
adding an edible component to the stabilizer;
cooling the stabilizer to a second temperature less than the first temperature and adding a scented component to the stabilizer; and
cooling the stabilizer to a third temperature less than the second temperature, wherein the stabilizer solidifies.

15. The method of claim 14, wherein the step of forming the depression in the exterior surface comprises using a boring bit capable of boring through high density salt, minerals, or combinations thereof.

16. The method of claim 14, wherein the stabilizer comprises paraffin wax, bees wax, or combinations thereof.

17. The method of claim 16, wherein the step of heating the stabilizer to the first temperature comprises heating the paraffin wax, the bees wax, or combinations thereof to a temperature ranging from 142 degrees Fahrenheit to 187 degrees Fahrenheit.

18. The method of claim 16, wherein the edible component comprises sugar, corn syrup, or combinations thereof.

19. The method of claim 18, wherein the step of adding the edible component comprises adding one ounce of sugar and two ounces of corn syrup to the stabilizer per pound of stabilizer.

20. The method of claim 16, wherein the step of cooling the stabilizer to the second temperature comprises cooling the stabilizer to approximately 145 degrees Fahrenheit, wherein the paraffin wax, bees wax, or combinations thereof remains liquid at the second temperature, and wherein the scented component comprises a boiling point less than the second temperature.
